(19) United States
(12) Patent Application Publication
(10) Pub. No.: US 2015/0095566 A1
(43) Pub. Date: Apr. 2, 2015

(54) Reading Speed of Updated File by Tape Drive File System

(71) Applicant: International Business Machines Corporation, Armonk, NY (US)

(72) Inventors: Hiroshi Itagaki, Tokyo (JP); Yutaka Oishi, Tokyo (JP)

(21) Appl. No.: 14/453,700

(22) Filed: Aug. 7, 2014

(30) Foreign Application Priority Data
Sep. 27, 2013 (JP) 2013-201140

(51) Int. Cl. G06F 17/30; G06F 3/06

(52) U.S. Cl. CPC G06F 17/30218; G06F 3/0682; G06F 3/0655; G06F 3/0619; G06F 2003/0698
USPC 711/111

(57) ABSTRACT

The mechanism provides for updating a file written on a medium in a system including a tape drive connected to a host. The mechanism receives, from the host, a change data part that is changed in the file as an update target. The mechanism writes the change data part to a data end position on the medium including a non-change data part that is not changed in the file sequentially stored on the medium. The mechanism calculates seek time required for positioning of a head of the tape drive from a medium position of the non-change data to a medium position of the change data part. The mechanism copies the change data part to an external storage device when the seek time is more than or equal to a predetermined value.

### BACKGROUND

The present invention relates to the reduction in time required for reading a file in a technique for reading and writing data on a tape medium via a tape drive file system. More specifically, the present invention relates to a method of improving the reading speed of a file fragmented by editing (changing) through a tape drive file system.

An LTFS (Linear Tape File System) can be used, as a tape drive file system, together with a fifth-generation LTO (Linear Tape-Open) tape drive (LTO-5) and a fourth-generation IBM enterprise tape drive TS1140. In general, when data written on a tape medium (tape, medium) are read in order, the same level of reading performance as a HDD (Hard Disk Drive) is provided. For example, in the case of LTO-5, it is possible to read data at a transfer rate of 140 MB/sec.

However, when the data to be read are scattered on the tape medium, since it requires 30 seconds on average and more than a minute order at most to align (seek) each piece of data, the average reading transfer rate is remarkably lowered. Further, the tape drive performs processing that takes two to five seconds to rewind a tape medium, called back hitch, in order to perform positioning to data parts fragmented on the medium. The back hitch operation for rewinding a tape is required to read fragmented file data, and this is a factor to reduce performance.

Japanese Patent Application Publication No. 2006-164017 describes that data before being appended and written is rewritten (defragged) to the appended/written data side to reduce the required reading time when data is appended and written.

### SUMMARY

In one illustrative embodiment, a method is provided for updating a file written on a medium in a system including a tape drive connected to a host. The illustrative embodiment receives, from the host, a change data part that is changed in the file as an update target. The illustrative embodiment writes the change data part to a data end position of the file including a non-change data part that is not changed in the file sequentially stored on the medium. The illustrative embodiment calculates seek time required for positioning of a head of the tape drive to a medium position of the change data part when data of the file that is not updated is aligned sequentially. The illustrative embodiment copies the change data part in an external storage device when the seek time is more than or equal to a predetermined value.

According to the above-mentioned method to which the present invention is applied, the reading speed of a file updated through the LTFS can be improved.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

FIG. 1 shows a tape divided into two LTFS partitions.

FIG. 2 shows an example of the hardware configuration of a storage system including a tape drive (magnetic tape drive) connected to a host to which the present invention is applied.

FIG. 3 shows such a state that the tape drive writes data while being reciprocated by an LTFS in the longitudinal direction of the tape, and after that, the tape drive changes partial data of multiple files.

FIG. 4 shows the contents of an index partition and a data partition of a medium in an LTFS format.

FIG. 5 shows changed contents of index information when File 1 of size L is partially rewritten.

FIG. 6 shows a flowchart of the present invention at the file update time.

FIG. 7 shows a flowchart of the present invention at the file read time.

### DETAILED DESCRIPTION

An embodiment for writing and reading a file to change the file in a storage system including a tape drive connected to a host will be described below. In the present invention, a file system detects that the position of the file on a tape medium is fragmented. In the embodiment, a part of the fragmented file is stored in a cache to reduce the time required for reading the file written on the tape medium in a fragmented manner.

The present invention is directed to a case where an application writes only a part of a file to update the file written on a tape medium. In other words, when a certain file is written dividedly to multiple areas on the tape medium, a part written upon updating (change data part) is stored in a cache other than the tape. The file part written upon updating (change data part) is recorded in an IP (Index Partition), and upon mounting the tape medium, a tape drive file system (LTFS) reads in advance file fragments recorded in the IP and copies the file fragments to a memory. Further, if the LTFS also holds the file fragments in an external cache such as a disk, the time required for reading the fragmented file can be reduced.

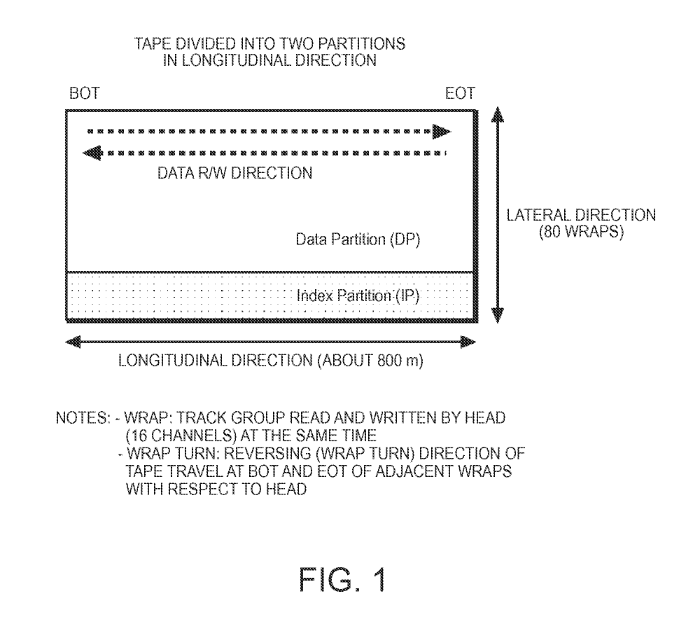

FIG. 1 shows a tape divided into two LTFS partitions. An LTO-5 tape drive writes data while traveling back and forth across wraps as write areas along the longitudinal direction of the tape. In the LTFS, two wraps (for one round) are used as the index partition. The tape is divided into two partitions IP and DP (Data Partition) across the length of the tape from the beginning of the tape (BOX) to the end of the tape (EOT). One wrap corresponds to 16 tracks as a track group read and written by a head at the same time. In an LTO-5 tape cartridge, the longitudinal direction of the tape is about 800 m and the lateral direction is a width corresponding to 80 wraps. The IP and the DP are divided by a protection area of two wraps (guard band). The tape travels back and forth in the longitudinal direction of the wraps, and reversing the travel direction at the BOT and the EOT is called a wrap turn. The travel time from the BOT to the EOT in the longitudinal direction of the tape with respect to the head of the tape drive is 60 to 90 seconds. The travel-time of the tape half the longitudinal direction is about 30 to 45 seconds. The storage capacity of the LTO-5 tape cartridge is about 1 TB. For example, although a user can change the capacity of the IP including medium information, the capacity of the IP typically accounts for 5 percent (50 GB) of the total capacity.

In a tape drive file system such as LTFS, data written on a medium can be shown as a file. When the tape medium is written by the user using the LTFS, meta-information called an index file (also simply called “index”) is written to the tape medium in addition to a file main body. The index includes, as meta-information, the file name and the creation date of the file, and position information and size information on the medium (extents). Principally, the latest index is written to the IP. The file main body and a history of indexes are written to the DP.

When a file on the tape medium is read and written using the LTFS, data are read and written in units of data structures called records. The record is managed by number for each partition in which the record is recorded, such as a number indicating what number from the beginning of the partition the record is. The correspondence between each file and records (e.g., information indicating that file A consists of records # N to # N+α) is also stored in the index.

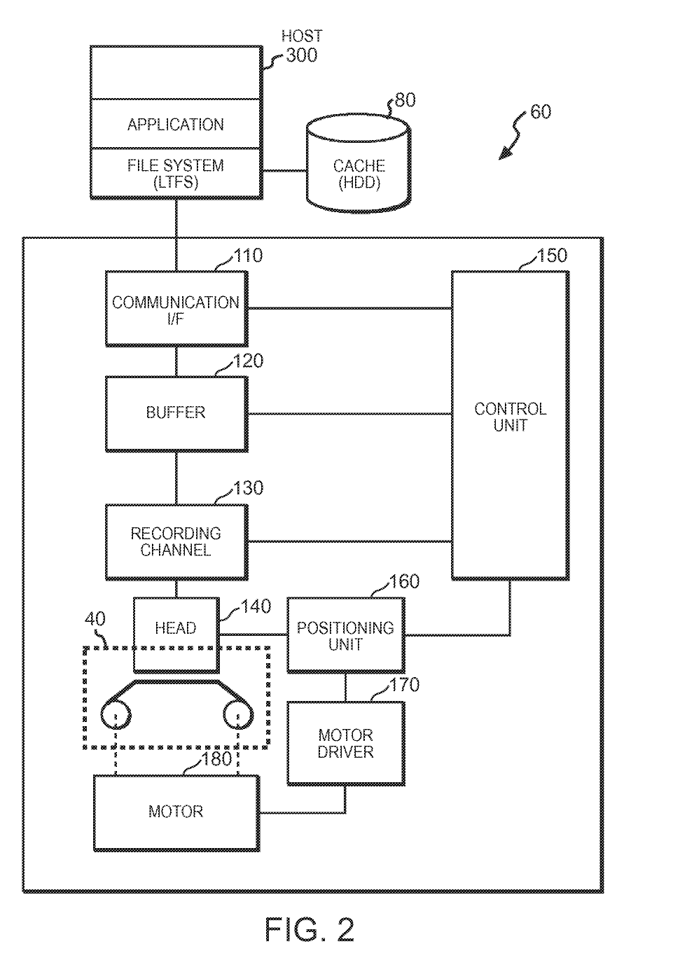

FIG. 2 shows an example of the hardware configuration of a storage system including a host and a tape drive (magnetic tape drive) to which the present invention is applied. A tape drive 60 receives a file read/write request from an application on a host 300 through a file system (LTFS). The tape drive includes a communication I/F (interface) 110, a buffer 120, a recording channel 130, a read/write head 140, a control unit 150, a positioning unit 160, a motor driver 170, and a motor 180.

The interface 110 performs communication with the host 300 through a network. For example, the interface 110 receives, from the host 300, a write command for instructing data writing to a tape cartridge (medium, tape medium) 40. The interface 110 also receives, from the host 300, a read command for instructing data reading from the medium 40. The interface 110 has the function of compressing write data and decompressing read data, increasing the storage capacity onto the medium nearly twice as large as the actual data.

The tape drive 60 performs reading from and writing to the medium 40 in units of data sets (DSs) each of which is made up of multiple records sent from the application on the host 300. The size of DS is typically 4 MB. In the host 300, the file system specifies a file and a SCSI command specifies records to send a write/read request (Write/Read) to the tape drive. The DS consists of multiple records.

Each DS includes management information on the data set. User data is managed in units of records. The management information is included in a data set information table (DSIT). The DSIT includes the number of records and the number of FMs included in the DS, and further the cumulative number of records and the cumulative number of FMs written from the beginning of the medium.

The buffer 120 is a memory for temporarily accumulating data to be written to the medium 40 or data read from the medium. For example, the buffer 120 is constituted by a DRAM (Dynamic Random Access Memory). The recording channel 130 is a communication channel used to write data accumulated in the buffer 120 to the medium 40 or to temporarily accumulate data read from the medium 40.

The read/write head 140 has a data read/write element to perform data writing to the medium 40 and data reading from the medium. The read/write head 140 according to the embodiment also has a servo reading element for reading a signal from a servo track provided on the medium 40. The positioning unit 160 instructs the travel of the read/write head 140 in the shorter side direction (width direction) of a cartridge 40. The motor driver 170 drives the motor 180.

The tape drive 60 writes data to the tape or reads data from the tape in accordance with the command received from the host 300. The tape drive 60 includes a buffer, a read/write channel, a head, a motor, reels on which a tape is wound, a read/write control, a head position control system, and a motor driver. The tape drive removably mounts the tape cartridge therein. The tape travels in the longitudinal direction along with the rotation of the reels. The head travels in the longitudinal direction of the tape to write data or read data from the tape. The tape cartridge 40 includes a non-contact nonvolatile memory called a cartridge memory (CM). The CM carried in the tape cartridge 40 is read and written by the tape drive 60 in a non-contact manner. The CM stores cartridge attributes. Upon reading and writing, the tape drive takes the cartridge attributes from the CM to enable the optimum reading and writing.

The control unit 150 controls the entire tape drive 60. In other words, the control unit 150 controls waiting of data to the medium 40 and reading of data from the medium 40 in accordance with the command received at the interface. The control unit 150 also controls the positioning unit 160 according to a read servo track signal. Further, the control unit 150 controls the operation of the motor through the positioning unit 160 and the motor driver 170. Note that the motor driver 170 may be connected directly to the control unit 150.

The tape drive 60 is loading the medium 40 on which a file to be updated is stored to read the index from the medium and copy the index to a cache 80. The cache 80 is an external storage device such as an HDD, an SDD, or a DRAM. The cache may also be a memory (DRAM) in the tape drive. The LTFS copies the index stored in the IP of the medium simultaneously with the time when the tape drive loads the medium. The LTFS can refer to the index copied in advance to the cache 80 to determine whether the file is fragmented.

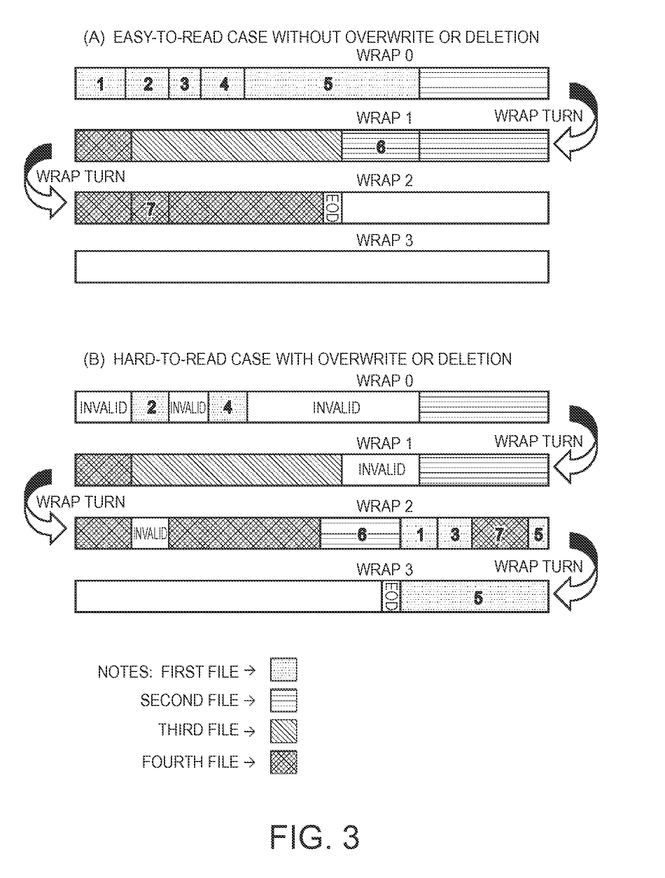

FIG. 3 shows such a state that the tape drive writes data while being reciprocated by the LTFS in the longitudinal direction of the tape, and after that, the tape drive changes partial data of multiple files. Each file is distinguished with a pattern. The upper figure (A) shows that respective files (first, second, third, fourth) are recorded continuously at first. The lower figure (B) shows data parts on the tape after each file is partially changed. Data parts 1, 3, and 5 of the first file are changed by being overwritten or deleted, but data parts 2 and 4 are not changed. In the second file, a data part 6 is changed. In the fourth file, a data part 7 is changed. The original data parts before being changed remain on the medium as invalid data. After the first file is changed, new data parts obtained by updating the data parts 1, 3, 5, and 6 are appended and written in order after the EOD (End of Data) of the file. In both (A) and (B), the order of reading the data parts of the first file from the medium is 1, 2, 3, 4, and 5. In the case of (B) after the file is changed, file fragments must be aligned on the tape with respect to the read head of the tape drive many times to read data parts from the beginning of the first file in order. The tape drive file system (LTFS) has a specific problem that it takes time to read a file sequentially because of the need to perform positioning at the file read time.

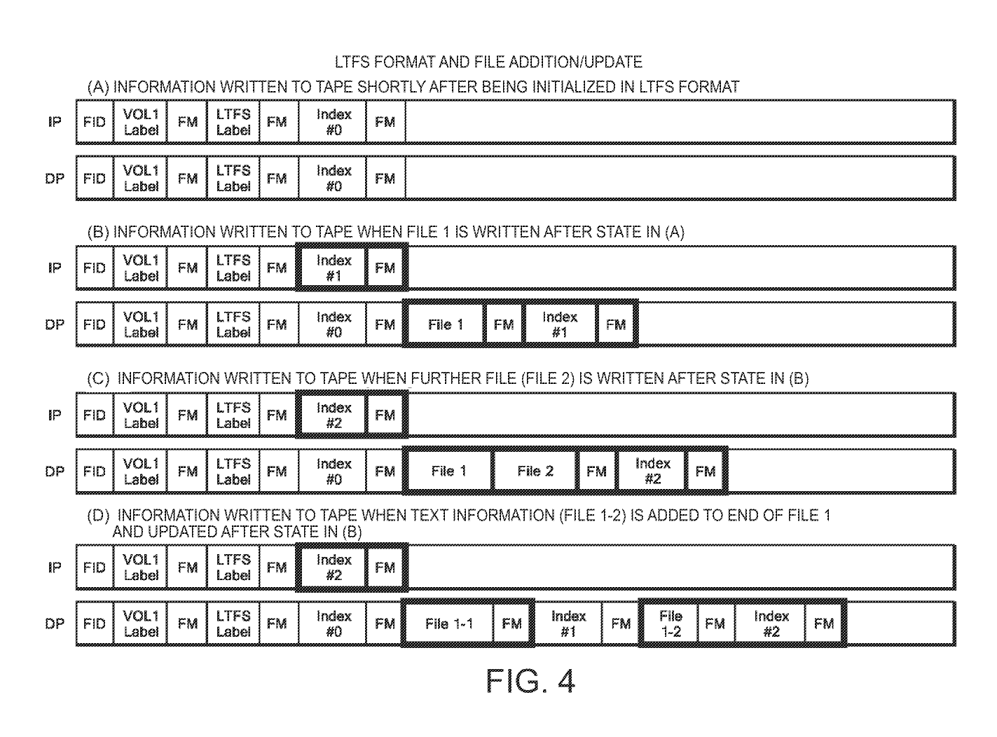

FIG. 4 shows changes in the contents of the index partition and the data partition as a result of adding and changing files on the medium in an LTFS format, (A) shows meta-information written on the tape medium shortly after being initialized in the LTFS format. The following pieces of information indicated in (A) are written to the tape medium shortly after the tape medium is initialized in the LTFS format:
FID (Format Identification Data set) is special data written at the beginning of the tape medium when the tape drive initializes the tape medium, and the special data contains information on the number of partitions on the tape medium, the capacity of each partition, and the like.
VOL 1 Label is also called an ANSI (American Nation Standards Institute) label that is literally a label in a common format defined in ANSI.
LTFS Label is a label defined in an LTFS format to hold information indicating to which version of the LTFS format the formatting of this tape medium conforms. Here, the size of records recorded on the medium is pointed out. The record size is also called a block size. Even when the end of the file is less than the record size (e.g., 512 KB), the record size is secured.
FM (Filemark) is, so to speak, a bookmark, and is commonly used on the tape medium to align (seek) data.
Index #0 is an index written during formatting. Since no file exists at this stage, there is no file-specific information, but the index is written to hold information on the volume name of the tape medium and the like.

FIG. 4(B) shows information written to the tape medium when a file is written after being initialized in the LTFS format. When a file (File 1) is written after being initialized in the LTFS format, data written on the tape medium is as shown in FIG. 4(B), where parts enclosed by heavy lines are added/updated data. Index #1 contains meta-information (index) on File 1. The IP holds only the latest index, while the DP holds a history of indexes. The timing of updating the index depends on the implementation of the file system, such as to update every fixed time or to update only when the tape medium is removed from the tape drive. Even when the tape medium continues to be further used, the index placed in the IP is always the latest index, and files and indexes are appended and written to the DP without overwriting existing indexes.

FIG. 4(C) shows information written to the tape medium when a file (File 2) is further written after the state in FIG. 4(B). When the next file (File 2) is added after the first file (File 1) is written on the tape medium, File 2 is stored on the tape medium to continuously follow File 1. Index #2 contains meta-information (index) on File 1 and File 2.

FIG. 4(D) shows meta-information written to the medium when text information (File 1-2) is added to the end of File 1 and updated after the state in FIG. 4(B). Depending on the application, an application designed for creating documents (e.g., Microsoft Word) records one file (File 1) in a fragmented manner like File 1-1 and File 1-2 after updating the file written on the medium. In the file rewriting, the reduced amount of free space on the tape medium at the update time depends on the amount of updated information. In other words, if the update amount is small even when the file size is large, since free space will be hardly reduced, there is no demerit in the capacity of the medium. However, since there is a need to perform positioning when a file is read, it takes time to read the file. Since the time required for the tape drive to perform positioning is enormously long compared with the hard disk, the problem of taking time to perform this positioning is a problem specific to the LTFS. The present invention is to provide a method of improving the reading time of a fragmented file.

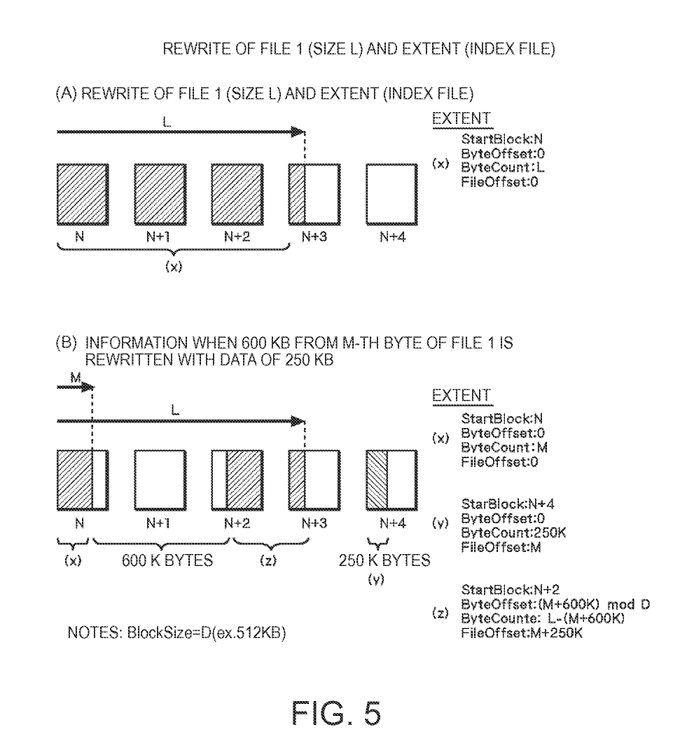

FIG. 5 shows changed contents of index information when File 1 of size L is partially rewritten. The index stores file position information (pointer) in a format called extent. The extent elements include the block number of a starting block (StartBlock) in a file part (data part), the start offset in the block of the number (ByteOffset), the data size (ByteCount), and the position of the data part in the file (FileOffset). User data is recorded on the medium in units of records having a size specified by the block size (e.g., 512 KB). StartBlock indicates the order of blocks having a fixed size from the beginning of the tape medium. ByteOffset indicates an offset the writing of which is started within a block having a specific number. ByteCount indicates the data size of a data part pointed out by the extent. FileOffset indicates the file position of a data part pointed out by the extent. Each block includes a record or an FM (FileMaker: a record separator), and the size is specified in the LTFS Label. The user data is recorded on the medium in units of records having a size specified by the block size (e.g., 512 KB).

When File 1 having size L is recorded on the medium at first in FIG. 5(A), the index indicates extent (x). File 1 is in a shaded area continuously written in units or records in the longitudinal direction of the tape medium. Each record corresponds to a block in the extent. When a data part is rewritten in FIG. 5(B), if 600 KB from the M-th byte of File 1 is rewritten with a 250 KB record after File 1 is written in FIG. 5(A), the index indicates information on extents (x), (y), (z). The extent (y) points out 250 KB of data (record) written by changing 600 KB of the data part in File 1, which is appended and written as a record of the following block number (StartBlock:N+4), rather than continuing the data part. The extent (y) appends and writes 250 KB from an offset with ByteOffset=0 in StartBlock=N+4. The extent (x) points out data (record) up to ByteCount=M in StartBlock=N. Then, 600 KB of data from offset M in block N is changed. The extent (z) indicates a data part of ByteCount=L−(M+600) from ByteOffset=(M+600K)mod D in StartBlock=N+2, where D denotes the block size (e.g., 512 KB), and ByteOffset is the remainder of dividing M+600 KB by D, giving an offset in the block with the block number N+2. The index of File 1 contains fragmented arrangement information as indicated by the multiple extents (x)→(y)→(z) resulting from rewriting the data part. When File 1 is edited by the LTFS, the extents are fragmented this way, and this disables sequential access to the changed File 1. The positioning of the extents (x)→(y)→(z) involves rewinding of the tape, causing a problem that reading performance is deteriorated.

In order to quantify the deterioration of reading performance, the “time required for positioning” is calculated. The “time required to align” the head of the tape drive to a data part on the medium is the reciprocating time between the position of a data part (non-change data part) that is not changed in the file by the update of the file and the position of a change data part in the file. Strictly speaking, the reciprocating time is the total time of the seek time for positioning from the tail position of the non-change data part to the leading position of the change data part, and the seek time for positioning from the tail position of the change data part to the leading position of the next change data part. The non-change data parts of the file are continuously appended and written in the longitudinal direction of the medium, whereas the change data parts are fragmented on the medium. It takes given time to align the head to the position of a change data part due to unnecessary travel distance and back hitch caused by reversing the direction. When numerous parts are edited, the seek time is excessively lengthened, and this is a factor to limit the improvement of reading performance. An embodiment to solve this problem will be described below.

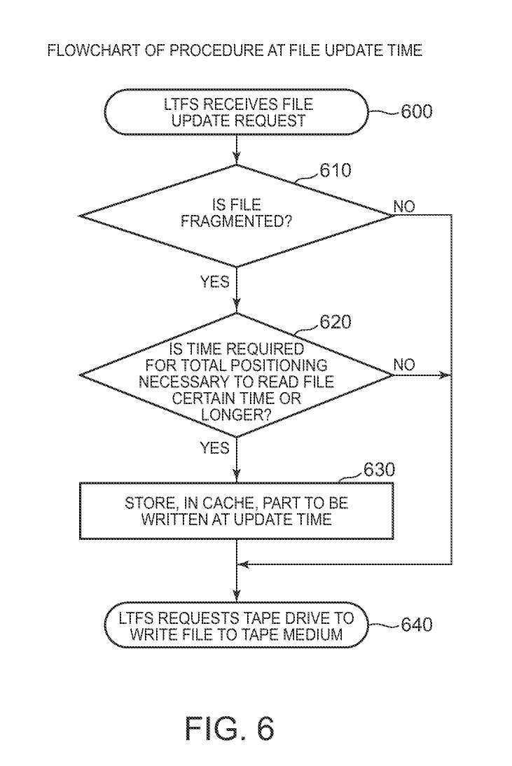

FIG. 6 is a flowchart of the present invention at the file update time. If the total seek time for positioning necessary to read a file is sufficiently short, conventional behavior may be adopted, while when positioning occurs, the cache may be always used. At step (600): The file system (LTFS) receives a file update request. The application on the host 300 makes a request through the LTFS to a file on the medium for partial changes. At step (610): The LTFS checks whether the file is fragmented. The tape drive 60 is loading the medium 40 on which the update target file is stored. An index is read from the medium 40, and copied to the external storage device (cache) 80. The external storage device may be a memory (DRAM) in the tape drive. The index stored in the IP of the medium is also loaded to the external storage device simultaneously with the time when the tape drive loads the medium. The LTFS refers to the index copied to the external storage device in advance to check whether the file is fragmented. Specifically, multiple extents in the index are analyzed to be able to check whether data parts of the file are fragmented like from the extent of the file before being updated in FIG. 5(A) to the extent after being rewritten in FIG. 5(B). When data fragments of the file are fragmented on the medium as a result of rewriting the file (YES), the procedure moves to processing in step 630.

At step (620): It is checked whether the seek time for total positioning necessary to read the file is a certain time or longer. The “seek time for total positioning” necessary to read the edited file is a total value of respective “times required for positioning” of multiple change data parts. Here, it is assumed that the number of change data parts in the edited file is only one. In this case, it is determined whether the “seek time for positioning” from the position of a non-change data part to the position of the change data part in the file on the tape medium is more than or equal to a threshold value determined statically or dynamically. For example, when the seek time for positioning can be determined to be more than or equal to twice the time (threshold value) required for back hitch (two to five seconds), the change data part is selectively copied to the cache or the like (step 630).

At step (630): Apart written at the update time is stored in the cache. The change data part stored in the IP is copied to the cache in advance. The position information on the cache to which the change data part is copied can be included in the index. At step (640): The LTFS requests the tape drive to write the file to the tape medium. Like in the conventional way, the change data part is appended and written to the end (EOD) of data in the DP of the medium. Further, in the present invention, the change data part is stored in the IP of the medium. Then, when the tape drive 60 mounts the medium 40 therein, the index and the change data part stored in the IP are copied to the cache 80 at the same time.

Note that the change data part may be stored in the cache 80 before being copied from the medium 40. The position information on the cache 80 to which the change data part is copied can be included as an extent in the index. Alternatively, the change data part can be stored in an HDD cache, rather than in the IP, at the file update time to omit the processing for reading file fragments from the IP in advance at the time of mounting the tape medium.

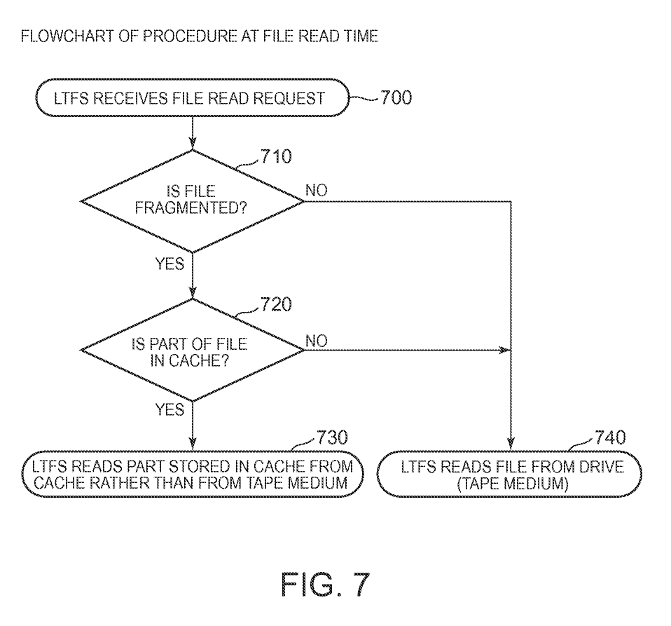

FIG. 7 shows a flowchart of the present invention at the file read time. At step (700): The LTFS receives a file read request. The application on the host 300 requests partial changes on the medium through the LTFS per file system unit. At step (710): It is checked whether the file is fragmented. The tape drive 60 is loading the medium 40 on which the update target file is stored. An index is read from the medium and copied to the cache 80. The external storage device may be a memory (DRAM) in the tape drive. When the tape drive loads the medium, the index stored in the IP of the medium is loaded to the external storage device at the same time. The LTFS refers to the index loaded to the external storage device ahead to check whether the file is fragmented. Specifically, extents in the index are analyzed to be able to check whether data parts of the file are fragmented like from the extent of the file before being updated in FIG. 5(A) to the extent after being rewritten in FIG. 5(B). When data fragments of the file are fragmented on the medium as a result of rewriting the file (YES), the procedure moves to processing in step 720. When data in the file is not fragmented on the medium (NO), the procedure moves to processing in step 740.

At step (720): It is checked whether a part of the file is in the cache. The LTFS can refer to the index to check whether the index and a change data part stored in the IP are stored in the cache 80. The check on the change data part in the cache may be made after the index and the change data part stored in the IP are copied to the cache simultaneously with the time when the tape drive loads the medium. The index includes an extent that points out the position information on the cache to which the change data part is copied. Therefore, the index (the extent in the index) can be referred to check whether the change data part exists in the cache. When the cache contains the change data part (YES), the procedure moves to processing in step 730. When the cache does not contain the change data part (NO), the procedure moves to processing in step 740.

At steps (730), (740): The part stored in the cache is read from the cache, rather than from the tape medium. The non-change data part is read sequentially through the buffer (step 740). The change data part is read from the external storage device (730). In the processing step 740, the positioning of the non-change data part to non-change data in the file on the medium can be read sequentially. Simultaneously, in step 730, since the positioning and travel of the head on the medium to the change data part of the edited file are omitted, the seek time for the positioning of the change data part can be omitted. Specifically, traveling a predetermined distance associated with the positioning from the non-change data part to the change data part of the edited file, and reversing the direction caused by back hitch, and deceleration/acceleration can be nullified. The LTFS refers to the index to eventually transfer, to the application, the non-change data part from the tape medium and the change data part from the cache sequentially as one edited file as a whole.

As described above, the method of the aforementioned embodiment can store a change data part in an external cache to improve the reading performance of an updated file. While the present invention has been described with reference to the embodiment, the scope of the present invention is not limited to the aforementioned embodiment. It is obvious to those skilled in the part that various changes and adoption of alternative modes are possible without departing from the spirit and scope of the present invention.

1. A writing method for updating a file written on a medium in a system including a tape drive connected to a host, comprising:
receiving, from the host, a change data part that is changed in the file as an update target;
writing the change data part to a data end position on the medium including a non-change data part that is not changed in the file sequentially stored on the medium;
calculating seek time required for positioning of a head of the tape drive from a medium position of the non-change data to a medium position of the change data part; and
copying the change data part to an external storage device when the seek time is more than or equal to a predetermined value.

2. The method according to claim 1, wherein the medium is divided into an index partition (IP) for storing an index of the file and a data partition (DP) for storing data of the file, the index includes metadata on data parts of the file stored in the DP and the IP, and the metadata includes respective pieces of position information (extents) on the data parts stored in the DP and the IP, the method further comprising:
storing the change data part in the index of the index partition, wherein position information on the data part of the file included in the index stored in the IP further includes position information on the external storage device in which the change data part is stored.

3. The method according to claim 2, wherein the tape drive copies the change data part from the IP to the external storage device simultaneously when loading the change data part.

4. The method according to claim 1, wherein the external storage device is a cache managed by the host or the tape drive.

5. The method according to claim 1, wherein the seek time is calculated based on a reciprocating time in which the head of the tape drive travels between a position of the change data part and a position of the non-change data part.

6. The method according to claim 2, wherein the seek time is calculated from position information (extents) on the change data part and the non-change data part included in the index stored in the IP.

7. The method according to claim 2, wherein the predetermined value is twice a seek time for back-hitch.

8. The method according to claim 2 further comprising:
receiving, from the host, a reading request for a changed file;
copying the index stored in the IP of the medium to the external storage device simultaneously when loading the index from the medium to the tape drive;
referring to the index of the medium to check whether the change data part of data in the file is fragmented on the medium with respect to the non-change data part that is not changed in the file as a reading target;
checking that the change data part is stored in the external storage device; and
reading the non-change data part sequentially from a buffer of the drive, reading the change data part from the external storage device, and transferring the data parts to the host in order as data of the updated file.

9. The method according to claim 8, wherein, when the change data part is not stored in the external storage device, the change data part stored in the IP is copied to the external storage device.

10. A writing system for updating a file written on a medium in a system including a tape drive configured to be coupled to a host, the system comprising:
a processor; and
a memory coupled to the processor, the memory comprising instructions which, when executed by the processor, causes the processor to:
receive, from the host, a change data part (change data part) that is changed in the file as an updated target;
write the change data part to a data end position of the medium including a non-change data part that is not changed in the file sequentially stored on the medium;
calculate seek time (seek time) required for positioning of a head of the tape drive from a medium position of the non-change data to a medium position of the change data part; and
copy the change data part to an external storage device when the seek time is more than, or equal to a predetermined value.

11. A computer program product for updating a file written on a medium in a system including a tape drive connected to a host comprising a computer readable storage medium having a computer readable program stored therein, wherein the computer readable program, when executed in a computing device, causes the computing device to:
receive, from the host, a change data part (change data part) that is changed in the file as an updated target;
write the change data part to a data end position of the medium including a non-change data part that is not changed in the file sequentially stored on the medium;
calculate seek time (seek time) required for positioning of a head of the tape drive from a medium position of the non-change data to a medium position of the change data part; and
copy the change data part to an external storage device when the seek time is more than or equal to a predetermined value.

12-13. (canceled)

14. The writing system according to claim 10, wherein the medium is divided into an index partition (IP) for storing an index of the file and a data partition (DP) for storing data of the file, the index includes metadata on data parts of the file stored in the DP and the IP, and the metadata includes respective pieces of position information (extents) on the data parts stored in the DP and the IP, the instructions further causing the processor to:
store the change data part in the index of the index partition, wherein position information on the data part of the file included in the index stored in the IP further includes position information on the external storage device in which the change data part is stored.

15. The writing system according to claim 14, wherein the drive copies the change data part from the IP to the external storage device simultaneously when loading the change data part.

16. The writing system according to claim 10, wherein the external storage device is a cache managed by the host or the tape drive.

17. The writing system according to claim 10, wherein the seek time is calculated based on a reciprocating time in which the head of the tape drive travels between a position of the change data part and a position of the non-change data part.

18. The writing system according to claim 14, wherein the seek time is calculated from position information (extents) on the change data part and the non-change data part included in the index stored in the IP.

19. The writing system according to claim 14, wherein the predetermined value is twice a seek time for back-hitch.

20. The writing system according to claim 14, wherein the instructions further cause the processor to:
receive, from the host, a reading request for a changed file;
copy the index stored in the IP of the medium to the external storage device simultaneously when loading the index from the medium to the tape drive;
refer to the index of the medium to check whether the change data part of data in the file is fragmented on the medium with respect to the non-change data part that is not changed in the file as a reading target;
check that the change data part is stored in the external storage device; and
read the non-change data part sequentially from a buffer of the drive, reading the change data part from the external storage device, and transferring the data parts to the host in order as data of the updated file.

21. The writing system according to claim 20, wherein, when the change data part is not stored hi the external storage device, the change data part stored in the IP is copied to the external storage device.

22. The computer program product according to claim 11, wherein the medium is divided into an index partition (IP) for storing an index of the file and a data partition (DP) for storing data of the file, the index includes metadata on data parts of the file stored in the DP and the IP, and the metadata includes respective pieces of position information (extents) on the data parts stored in the DP and the IP, the instructions further causing the processor to:
store the change data part In the index of the index partition, wherein position information on the data part of the file included in the index stored in the IP further includes position information on the external storage device in which the change data part is stored.
